(19) United States
(12) Patent Application Publication
(10) Pub. No.: US 2024/0067463 A1
(43) Pub. Date: Feb. 29, 2024

(54) CONVEYING FACILITY

(71) Applicant: Ferag AG, Hinwil (CH)

(72) Inventors: Markus Bretz, Hinwill (CH); Roberto Fenile, Hinwil (CH)

(21) Appl. No.: 18/454,309

(22) Filed: Aug. 23, 2023

(30) Foreign Application Priority Data
Aug. 25, 2022 (CH) 000997/2022

(51) Int. Cl. B65G 47/52; B65G 43/08

(52) U.S. Cl. CPC B65G 47/525; B65G 43/08; B65G 2203/0208

(57) ABSTRACT

A conveying facility with a feed conveying device, a take-over conveying device and a control device, for transferring horizontally or lying conveyed goods from the feed conveying device to the take-over conveying device, wherein the conveying facility forms a transfer region, in which the conveyed goods are transferred from the feed conveying device to the take-over conveying device. The conveying facility includes a transfer assistance device which is designed to act in the transfer region by way of pressurised gas from below onto at least one conveyed good being moved past.

### BACKGROUND OF THE INVENTION

### Field of the Invention

The invention lies in the field of conveying technology, in particular conveying technology for intralogistics. The invention relates to a conveying facility with a feed conveying device, a take-over conveying device and a control device, for transferring horizontally or lying conveyed goods from the feed conveying device to the take-over conveying device, wherein the conveying facility forms a transfer region, in which the conveyed goods are transferred from the feed conveying device to the take-over conveying device.

### Description of Related Art

Ever increasing quantities of conveyed goods of a different nature such as parcels or bagged goods are processed in logistics centres due to the increasing online trade. Bagged goods are to be understood as goods, such textiles or pieces of clothing, which are packaged in bags, in particular plastic bags.

The large quantities of conveyed goods as well as their different nature are a huge challenge for logistics centres. For instance, the conveyed goods are to be processed in the logistics centres as quickly and correctly as possible, so that these reach their recipient as rapidly as possible. Furthermore, whenever possible the processing of the conveyed goods should take place without disturbances, so that there are no downtimes of the facility.

In the logistics centres, the arriving conveyed goods are fed into sorting and distribution systems. For this, the arriving conveyed goods as a rule are put onto the conveying surface of an infeed appliance as horizontal or lying goods. The infeed appliance feeds the conveyed goods to a sorting conveyor, also called sorter, and transfers them to this.

Conveying facilities with a sorting conveyor and an associated infeed appliance are known, for example, from the published documents DE 103 46 122 A1, EP 3 284 705 A1, WO 2016/067163 A1 and WO 2021/113594 A1.

The sorter can be designed for example as a so-called tilt-tray conveyor which includes conveying trays which can be tilted for delivering the conveyed goods. By way of the tilt-tray conveyor, the conveyed goods are conveyed in tilt trays along the delivery zone past delivery locations. As soon as the conveyed good has reached the correct delivery location, the tilt tray is brought into an oblique position via a tilting mechanism and the conveyed goods slide laterally away from the conveying tray at the respective delivery location.

Alternatively, the tilt trays can be tilted even before the delivery zone, wherein the delivery of the conveyed good at the correct delivery location is effected by way of pivoting a lateral wall which is at the delivery side and is situated lower, from a closure position into an open position, e.g. by way of folding or pivoting the lateral wall up or down.

Apart from parcels, goods are increasingly processed in bags such as plastic bags. These are hereinafter denoted as bagged goods. The goods which are packaged in bags are often textiles, such as pieces of clothing or printed products such as brochures or magazines. Accordingly, these bagged goods are flexible and are often limp. In particular, the emerging online trade with clothes is leading to an increase in bagged goods.

However, the processing of such bagged goods creates difficulties which are less of a problem or do not even exist in the case of parcels. Thus, for example the adhesion between the convening surface and the bagged goods becomes a problem given the transfer between two conveying devices. The pronounced adhesion in the case of bagged goods on the one hand is down to the flexible characteristics of the bagged goods, which can lead to the bag surface being able to snuggle onto the conveying surface of the conveying member, by which means the contact surface area to the conveying member is increased. Furthermore, the different packaging materials also have different adhesion characteristics. For instance, bag envelopes of plastic tend to have a greater adhesion than for example the cardboard packaging of parcels.

A further reason for a different behaviour of the conveyed goods on transfer is also due to the flexible characteristics of the bagged good compared to shape-stable parcels. If for instance a parcel is transferred from a feed conveyor to a take-over conveyor, then the feed conveyor pushes the parcel onto the take-over conveyor until the parcel loses contact with the conveying member of the feed conveyor. This is also the case if the parcel with a front section is already lying on the conveying member of the take-over conveyor and counteracts the transfer in a braking manner due to the occurring sliding friction. The shape-stable parcel thus obtains the movement energy which is necessary for covering the transfer stretch from the conveying member of the feed conveying device.

If, however, a flexible bag is transferred from a feed conveyor to take-over conveyor, then the sliding friction or static friction which originates from the front section which is already lying on the conveying member of the take-over conveyor counteracts the transfer in a manner such that the feed conveyor is no longer capable of pushing the bag further onto the take-over conveyor, but in contrast squashes this. In other words, the bagged goods, having been provided with the kinetic energy which it obtains from the conveying member of the feed conveying device does not fully cover the envisaged transfer stretch due to the lack of shape stability.

This problem is amplified further given the presence of a conveying gap between the feed conveying device and the take-over conveying device, since no conveying thrust is present in this section of the transfer stretch.

Furthermore, there is also the danger of folding in the case of limp bagged goods. By way of this, the bagged good can get stuck on obstacles such as projections, or in gaps.

The aforementioned difficulties lead to the bagged good not being transferred completely onto the take-over conveyor or at least not into the desired conveying position on the take-over conveyor.

Not only bagged goods but other, in particular lightweight and flexible or limp conveyed goods can also cause problems on transfer. For this reason the term “sensitive conveyed goods” is therefore used very generally in this context.

### SUMMARY OF THE INVENTION

It is then the object of the present invention to put forward a conveying facility which ensures an accurately targeted, error-free and malfunction-free transfer of the conveyed goods even in the case of sensitive conveyed goods, such as bagged goods.

Moreover, it is also an object of the present invention to put forward a conveying facility which ensures a gentle transfer or a gentle take-over of conveyed goods, in particular of sensitive conveyed goods such as bagged goods, between a feed conveying device and a take-over conveying device.

Furthermore, it is an object of the invention to utilise already existing appliances so as to minimise the costs and the installation effort.

The conveying facility according to the invention includes a feed conveying device, a take-over conveying device as well as a control device and is designed for transferring horizontally or lying conveyed goods from the feed conveying device to the take-over conveying device. For this, the conveying facility forms a transfer region, in which the conveyed goods are transferred from the feed conveying device to the take-over conveying device.

The invention is characterised in that the conveying facility includes a transfer assistance device which is designed to act in the transfer region by way of pressurised gas from below onto at least one conveyed good being moved past.

In particular, the transfer region corresponds to that transport section, in which the conveyed good with a leading first section is already arranged over the conveying member of the take-over conveyor and with a trailing second section is still arranged over the conveying member of the feed conveyor.

The conveying path corresponds to that part of the transport path of the conveyed goods, in which the conveyed goods are conveyed by way of a conveying member.

The transport path generally corresponds to the movement path of the conveyed goods over several conveying devices as well as a transfer region. The width of the transport path defines that extension transverse to the transport direction, within which the conveyed goods can be arranged along the transport path.

In particular, the width of the transfer region corresponds to the width of the transport path.

What is understood by pressurised gas is a gas or gas mixture which under pressure flows out of the transfer assistance device, e.g., out of at least one gas outflow opening.

In particular, the pressurised gas is pressurised air, as is also used for other purposes in conveying facilities. In particular, the pressurised gas is made available to the transfer assistance device by a pressurised gas supply and very particularly by a pressurised air supply via suitable pressurised gas and pressurised air conduits. Accordingly, the conveying facility in particular also includes a pressurised gas supply or is connected to such via a pressurised gas conduit.

The pressurised gas supply, also called pressurised gas supply device, can include a pressurised gas generator or pressurised air generator, such as a compressor, by way of which pressurised gas or pressurised air is produced.

The pressurised gas supply can include a pressurised gas store or pressurised air store, by way of which the pressurised gas or the pressurised air is provided.

The transfer assistance device in particular includes at least one gas outflow opening, by way of which pressurised gas can flow from below onto the at least one conveyed good which is moved past.

The transfer assistance device or its at least one gas outflow opening is designed in particular for the targeted expulsion or outflow of pressurised gas.

In particular, the transfer assistance device can include at least one pressurised gas nozzle which forms the at least one gas outflow opening. In particular, by way of the pressurised gas nozzle, pressurised gas can be directed from below onto the at least one conveyed good being moved past.

The at least one pressurised gas nozzle can be a slot nozzle or a round nozzle.

The transfer assistance device can include an outflow body which includes the at least one gas outflow opening or pressurised gas nozzle.

In particular, the at least one gas outflow opening and as the case be may be the outflow body are arranged below the conveying path or transport path of the conveyed good.

In particular, the at least one gas outflow opening and as the case may be the outflow body are formed below the level of the conveying surfaces of the feed conveying device and of the take-over conveying device.

The outflow body with the at least one gas outflow opening is arranged in particular in a stationary, i.e. spatially fixed manner. In particular, the outflow body with the at least one gas outflow opening is arranged in an immovable manner.

In particular, the terms stationary and spatially fixed means that the respective components or element as a whole cannot be displaced.

In particular, the at least one gas outflow opening is arranged in a stationary, i.e. spatially fixed manner.

The characteristics such as stationary or spatially fixed or immovable in particular relate to the conveying facility during its operation. Thus, the respective components can indeed be designed in a movable manner for maintenance work during a standstill of the facility.

It is conceivable for the outflow body with the at least one gas outflow opening to be arranged in a stationary, i.e. spatially fixed manner and for the at least one gas outflow opening to be movably arranged.

If the at least one gas outflow opening is part of a pressurised gas nozzle, then the at least one pressurised gas nozzle and with this the associated at least one gas outflow opening can be designed in a movable manner. The pressurised gas nozzle can, for example, be pivotable. Despite this, the pressurised gas nozzle can be arranged in a stationary manner.

In particular, the at least one gas outflow opening is arranged in front of the take-over conveying device considered in the conveying direction.

In particular, the at least one gas outflow opening gas is arranged between the conveying member of the feed conveying device and conveying member of the take-over conveying device considered in the conveying direction.

In particular, the at least one gas outflow opening is arranged between the feed conveying device and the take-over conveying device considered in the conveying direction.

In particular, the transfer assistance device includes a valve, such as e.g. an outlet valve, via which the feed of pressurised gas to the at least one gas outflow opening or to the outflow body can be controlled. Thus, in particular the expulsion of pressurised gas out of the at least one gas outflow opening can be switched on and switched off by way of the valve.

According to a further development, in particular the quantity of the pressurised gas which is expelled from the at least one gas outflow opening (per unit of time) can be controlled by way of the valve. In particular, the valve is controlled by the control device, to which this is connected.

The term “connected” in the context of the control device is not limited to a physical lead connection. The connection of components to the control device can also be wireless. This is particularly the case if it is merely a question of the transmission of data such as control commands or measurement data.

According to a further development of the invention, a conveying gap is formed in the transfer region between the feed conveying device and the take-over conveying device. The transfer assistance device is designed such that the pressurised gas acts from below through the conveying gap onto the at least one conveyed good which is moved past above.

A conveying gap is generally to be understood as a path section between two conveyors along the transport path, in which section no conveying member for conveying the conveyed good is arranged. The conveying gap as a rule extends over the complete width of the transport path of the conveying device.

The conveying gap in the present case can be present in the form of a gap (conveying gap) or slot which is arranged between the feed conveying device and the take-over conveying device.

However, the conveying gap can also be bridged by a stationary guide element which forms a rest surface and in particular a sliding surface for the conveyed good to be transferred. The guide element can be, e.g., a rest plate.

It is also possible for the transfer assistance device itself to form such a guide element. In this case, the guide element in particular is part of the outflow body, wherein the at least one gas outflow opening is arranged in the guide element or in the rest surface or sliding surface.

Alternatively, the guide element or its rest surface or sliding surface can include gas throughflow openings, through which the pressurised gas which flows out of the outflow body from below, e.g. via pressurised gas nozzles, can flow upwards.

The transfer assistance device can be designed such that pressurised gas is directed from below onto the at least one conveyed good which is moved past above, over the complete width of the transfer region or of the transport path of the conveyed goods transversely to the transfer direction.

In particular, the transfer direction corresponds to the conveying direction of the conveyed good in the transition from the feed conveying device to the take-over conveying device. The transfer direction can deviate from the conveying direction of the feed conveying device and the take-over conveying device.

In particular, the transfer assistance device includes several gas outflow openings.

In particular, the transfer assistance device includes several gas outflow openings which are arranged successively in the transfer direction.

The gas outflow openings can be arranged offset to one another in the transfer direction or in a row or rows one after the other.

In particular, the transfer assistance device includes several gas outflow openings which are successively arranged transversely to the transfer direction.

The gas outflow openings can be arranged offset to one another transversely to the transfer direction or in a row or rows one after the other. This means that considered in the transfer direction, the gas outflow openings can be arranged next to one another in a row or in rows.

If the transfer assistance device includes several gas outflow openings, then these can be arranged in a one-dimensional manner, e.g., in a row transversely to the transfer direction. However, it is also possible for a multitude of gas outflow openings to be arranged in a manner distributed over an area, e.g., in a two-dimensional matrix. In particular, this two-dimensional arrangement extends over the complete width of the transfer region. In particular this is the case given a combination of several gas outflow openings which are arranged successively in the transfer direction as well as transversely to the transfer direction.

The two dimensional arrangement of gas outflow openings can correspond to an in particular regular pattern, such as, e.g., a raster. The two-dimensional arrangement of gas outflow opening can also be random.

According to an embodiment, the transfer assistance device includes at least one slot nozzle for pressurised gas which extends transversely to the transfer direction. The slot nozzle can extend over the complete width of the transfer region.

The pressurised gas which in the transfer region acts from below upon a conveyed good, in particular effects a lift at the respective conveyed good.

The lift can, e.g., help the transport of the conveyed good over an obstacle in the transfer region. Such an obstacle can be e.g. the raised edge of the conveying tray of a tray conveyor.

Hence a gas cushion, e.g., an air cushion, can be formed by the pressurised gas which flows on from below, between the conveying member of the take-over conveying device, in particular its conveying surface, and a conveyed good which is arranged in the transfer region with at least one section over the conveying surface of the take-over conveying device.

Furthermore, a gas cushion, e.g., an air cushion, can be formed by the pressurised gas which flows on from below, between the conveying member of the feed conveying device, in particular its conveying surface, and a conveyed good which is arranged in the transfer region with at least one section over the conveying surface of the feed conveying device.

The pressurised gas which flows onto the conveyed good from below in the transfer region can lift or reduce the static friction between the conveyed good which is subjected to onflow and parts of the take-over conveying device, in particular the conveying member of the take-over conveying device.

The pressurised gas which flows onto the conveyed good from below in the transfer region can lift or reduce the static friction between the conveyed good which is subjected to onflow and parts of the feed conveying device, in particular the conveying member of the feed conveying device.

The pressurised gas which flows onto the conveyed good from below in the transfer region can reduce the sliding friction between the conveyed good which is subjected to onflow and parts of the take-over conveying device, in particular the conveying member of the take-over conveying device.

The pressurised gas which flows onto the conveyed good from below in the transfer region can reduce the sliding friction between the conveyed good which is subjected to onflow and parts of the feed conveying device, in particular the conveying member of the feed conveying device.

One can envisage the level of the conveying surface of the conveying member of the feed conveying device in the transfer region being higher than the level of the conveying surface of the conveying member of the take-over conveying device, so that the conveyed good in the transfer region is transferred obliquely from above onto the lower lying conveying member of the take-over conveying device.

In this case, the pressurised gas which flows on from below can act upon the flight path of the conveyed good which falls onto a conveying member lying at a lower level, by way of the pressurised gas giving the conveyed good for example additional lift. Thus the flight path of the conveyed good can be extended and/or its angle of incidence changed, in particular a reduced, by way of the pressurised gas which acts upon it.

The transfer assistance device accordingly permits a controlled transfer of the conveyed goods between the feed conveying device and the take-over conveying device.

The transfer assistance device can be designed such that the pressurised gas flows or is directed perpendicularly from below against the at least one conveyed good which is moved past above.

According to a further development of the invention, the transfer assistance device is designed such that the outflowing pressurised gas flows or is directed from below with a horizontal direction component against or onto the at least one conveyed good which is moved past.

The outflowing pressurised gas thus has a horizontally as well as a vertically upwardly directed flow component. This means that the outflowing pressurised gas flows obliquely from below against the at least one conveyed good which is moved past above.

The horizontal direction component is accordingly a flow component which is directed to the side. This component can be directed in the transfer direction or conveying direction. This component can be directed counter to the transfer direction or conveying direction. These components can also be directed transversely to the transfer direction or conveying direction.

One can envisage the gas flows which flow out of several gas outflow openings each having different horizontal direction components.

Hence gas outflow openings which give the gas flow a direction component in the transfer direction or conveying direction can be combined with gas outflow openings which give the gas flow a direction component counter to the transfer direction or conveying direction. Furthermore, these gas outflow openings can yet be combined with gas outflow openings, concerning which the pressurised gas flows out vertically upwards.

The pressurised gas can flow out in a directed manner by way of the application of pressurised gas nozzles which include gas outflow openings.

The outflow of the pressurised gas with a horizontal direction component, particularly if this is effected from several gas outflow openings permits the conveyed good to be subjected to onflow over a large surface area.

Furthermore, the outflow of pressurised gas with a horizontal direction component also permits the conveyed good to be subjected to onflow in regions, below which no gas outflow openings are placed. Thus an obliquely directed pressurised gas flow with a horizontal direction component can reach to between the conveying member of the take-over conveying device and the conveyed good or to between the conveying member of the feed conveying device and the conveyed good.

The feed conveying device can be a single conveyor. In particular, the feed conveying device is designed for the horizontal or lying conveying of the conveyed goods. Accordingly, the feed conveying device or its conveying member or conveying members forms a conveying surface or conveying surfaces, in particular a plane conveying surface or plane conveying surfaces.

The feed conveying device can be a belt conveyor with a driven conveying belt.

The feed conveying device can be a modular belt conveyor with a driven modular belt.

The feed conveying device can be a plate chain conveyor with a driven plate chain.

The feed conveying device can be a mat chain conveyor with a driven mat chain.

The feed conveying device can be a roller track with driven rollers.

The feed conveying device can be a parallel belt conveyor or strip belt conveyor. The parallel belt conveyor or strip belt conveyor includes several driven conveying belts or conveying strip belts which are arranged parallel to one another in conveying direction and in particular distanced to one another. The parallel belts or strips are equally directed driveable.

The feed conveying device can also be of several conveyors which are arranged successively in the conveying direction. In particular, the conveying members of the conveyors move in an equally directed manner, i.e. in the same direction.

The conveyors can be of the same type. The conveyors can also be of different types. Thus, the feed conveying device can include two or more than two conveyors of a type mentioned above.

The feed conveying device can be designed and arranged such that the conveyed goods are fed laterally, i.e. from the side to the take-over conveying device. The feed conveying device can be designed such that the conveyed goods are fed at an acute angle of smaller than 90° (angle degrees), in particular smaller than 70° from the side to the take-over conveying device. The conveyed goods however can also be fed at a right angle, i.e. at an angle of 90°, laterally to the take-over conveying device.

If the feed of the conveyed goods is effected laterally at an acute angle of less than 90°, then the feed conveying device in particular includes a parallel belt conveyor or strip belt conveyor which are adjacent to the take-over conveying device or consists of such.

It is also possible for the feed conveying device to feed the conveyed goods at the face side of the take-over conveying device. At the face side means that the conveying directions of the feed conveying device and of the take-over conveying device are equally directed in the transfer region.

The feed conveying device can be a part of an infeed appliance. The feed conveying device forms or includes the last conveyor of the infeed appliance in the conveying direction before the transfer. In particular, this last conveyor can be a parallel belt conveyor or strip belt conveyor. The infeed appliance can further include a supply conveyor which feeds the conveyed goods to the feed conveying device and transfers them to this.

The take-over conveying device in particular is designed for the horizontal or lying conveying of the conveyed goods. Accordingly, the take-over conveying device or its conveying member forms a conveying surface or conveying surfaces, in particular a plane conveying surface or plane conveying surfaces for the conveyed goods.

The take-over conveying device can be a belt conveyor with a driven conveying belt.

The take-over conveying device can be a modular belt conveyor with a driven modular belt.

The take-over conveying device can be a plate chain conveyor with a driven plate chain.

The take-over conveying device can be a mat chain conveyor with a driven mat chain.

The take-over conveying device can be a roller track with driven rollers.

The take-over conveying device can be parallel belt conveyor or a strip belt conveyor of the type already described above.

The take-over conveying device can be a transverse parallel belt conveyor.

The take-over conveying device can be a shoe conveyor.

In particular, the take-over conveying device is a sorting conveyor or sorter. In particular, the sorter is a conveying revolving apparatus. Accordingly, the take-over conveying device and the feed conveying device in particular are part of a sorting facility or the conveying facility corresponds to a sorting facility.

The sorting conveyor is designed to deliver conveyed goods to predefined delivery stations which are arranged along the conveying path of the sorting conveyor.

For instance, the published documents WO 2017/076541 A1 and WO 2013/075714 A1 each describe a sorting conveyor with tiltable conveying stretch segments for sorting conveyed goods, such as for example parcels.

The take-over conveying device in particular is a conveyor with a conveying member which forms discrete conveying units such as conveying trays or conveying plates. The discrete conveying members can be interlinked to one another. Accordingly, the conveyed goods are transferred from the feed conveying device to the conveying units of the take-over conveying device in particular in a cycled manner.

In particular, the take-over conveying device is a tray conveyor, very partially a tilt-tray conveyor. The tray conveyor is characterised by a multitude of conveying trays which are arranged one after the other along the conveying path and in particular are interlinked to one another. The conveying trays each form a receiving compartment with a conveying surface for the conveyed good. In particular, the receiving compartment corresponds to a conveying space or conveying place for a conveyed good.

Concerning a tilt-tray conveyor, the conveying trays via a tilting mechanism are tiltable laterally considered in the conveying direction for the purpose of delivering conveyed goods. Such a tilt-tray conveyor is described, e.g., in U.S. Pat. No. 5,632,589 A.

The conveying trays can have pivotable side walls which for delivering the conveyed goods can be pivoted from a closure position which laterally hold back the conveyed good into an open position, in which the conveyed good can slide away from the conveying tray. Thus the side walls for example can be folded or pivoted down, so that the conveyed good via the folded down side wall can laterally slide away from the conveying tray seen in the conveying direction. The published document CH 710 851 A1 describes such a tilt-tray conveyor.

The take-over conveying device can also very generally be an aforementioned conveyor. The conveyor can a include a plurality of conveying trays which lie loosely on the conveying member of the conveyor and which via an inclining device can be set obliquely for the purpose of the delivery of the products. Such a conveyor is disclosed, e.g., in WO 2019/042761 A1 and in EP 3 450 355 A1.

If conveyed goods of a different weight and of a different nature such as e.g. parcels and bagged goods are to be transferred to the take-over device by way of the feed conveying device, then under certain circumstances not all conveyed goods require an assisting action by the transfer assistance device by way of pressurised gas.

Thus in particular lightweight and limp conveyed goods, e.g., bagged goods, require a transfer assistance according to the invention by way of pressurised gas which acts upon the conveyed good from below. Heavy and in particular rigid conveyed goods, such as, e.g., parcels, as a rule can already be transferred without any problem for the already aforementioned reasons. Accordingly, it is sufficient if the transfer assistance device or the expulsion of pressurised gas is only activated given the sensitive conveyed goods.

For this, in a further development of the invention, the conveying facility can include a sensor device for the detection of the presence and as the case may be also at least one characteristic of the conveyed goods which are fed to the transfer region.

The sensor device in particular can detect the presence and as the case may be also at least one characteristic of the conveyed goods which are conveyed on the feed convening device or on a conveyor, in particular of the infeed appliance, which is arranged in front of the feed conveying device in the conveying direction.

In particular, the sensor device can detect the presence and as the case may be also at least one characteristic of the conveyed goods which are conveyed on the infeed appliance.

In particular, the sensor device can include an opto-electronic sensor unit. The opto-electronic sensor unit can be, e.g., a light barrier. In particular, the opto-electronic sensor unit is a camera.

The sensor device can include scales or a weighing system for weighing the conveyed goods which are fed to the transfer region. The weighing can be effected, e.g., during the conveying of the conveyed goods.

The scales or the weighing system can determine the mentioned weight for example during the conveying of the conveyed goods on the feed conveying device.

The scales or the weighing system can determine the mentioned weight for example during the conveying of the conveyed goods on a conveyor which is arranged in front of the feed conveying device in the conveying directing.

The scales or the weighing system can determine the weight in particular in the infeed appliance.

In particular, the sensor device is designed for detecting at least one of the following characteristics of the conveyed goods which are fed to the transfer region:
shape of the conveyed good
height of the conveyed good
width of the conveyed good
size of the conveyed good;
weight of the conveyed good;
alignment of the conveyed good.

In particular, the sensor device is designed for detecting several of the characteristics which are mentioned above.

As is explained hereinafter in more detail by way of the method, the sensor device permits a sensor-based control of the transfer assistance device.

According to a further development of the invention the control device is designed to control the expulsion of pressurised gas such that the at least one conveyed good is transferred to a predefined conveying space in the take-over conveying device in an accurately targeted manner.

According to a refinement of this further development the control device is designed to control the expulsion of pressurised gas in dependence on the at least one detected characteristic, such that the at least one conveyed good is transferred to a predefined conveying space in the take-over conveying device in an accurately targeted manner.

The invention also relates to a method for the transfer of conveyed goods from a feed conveying device to a take-over conveying device by way of a conveying facility which has been described above.

According to the method, at least one conveyed good in the transfer region is subjected to onflow from below by a pressurised gas by way of the transfer assistance device.

Due to the conveyed good being subjected to onflow by the pressurised gas from below, the conveyed good in particular experiences a lift, thanks to which the conveyed good in combination with the kinetic energy obtained from the conveying member of the feed conveying device can cover the envisaged transfer stretch. By way of this, it is ensured that the conveyed good reaches its envisaged conveying location on the take-over conveying device.

The lift in particular ensures that the static friction or sliding friction reduces and that the friction losses, i.e. the loss of kinetic energy consequently reduce during the transfer.

According to a further development of the invention, the at least one conveyed good in the transfer region is subjected to onflow obliquely from below by pressurised gas by way of the transfer assistance device.

According to a further development of the invention, the at least one conveyed good in the transfer region is subjected to onflow from below by pressured gas transversely to the transfer direction over the entire width of the transfer region by way of the transfer assistance device.

According to a further development of the invention, the pressurised gas flows through a conveying gap in the transfer region from below onto the at least one conveyed good.

According to the further development of the invention which has already been mentioned above, at least the presence of a conveyed good which is fed to the transfer region is detected by way of the sensor device.

For this, the sensor device is connected to the control device which in turn is also connected to the transfer assistance device and controls this. In particular, the control is effected via the (outlet) valve.

In this context, the conveying facility in particular also includes an evaluation device which evaluates the signals of the sensor device by way of evaluation software and from this generates control commands for the control of the transfer assistance device.

Thus, one can envisage the control device activating the transfer assistance device or the expulsion of pressurised gas when the sensor device detects the presence of a conveyed good. Since the sensor device detects the conveyed goods upstream of the transfer assistance device, the control device activates the transfer assistance device or the expulsion of pressurised gas in particular with a time-delay.

After completion of the transfer of the conveyed good, the control device can again deactivate the transfer assistance device or the expulsion of pressurised air until the arrival of the next conveyed good.

Alternatively to activating and deactivation the transfer assistance device or the expulsion of pressurised gas, an already present (underlying) expulsion of pressurised gas can be increased at the beginning of the transfer and be reduced again after the transfer has been effected.

The evaluation device is not necessarily to be considered as a separate closed-off physical unit.

The evaluation device can be part of the control device. The evaluation device can also be part of the sensor device.

Furthermore, it is also possible for certain functions of the evaluation device, such as the evaluation of sensor data, to be implemented in the sensor device and for other functions such as the generation of control commands from the evaluation data to be implemented in the control device.

According to a further development of this further design, the senor device is designed to determine or detect at least one characteristic of the conveyed good, which permits or simplifies the identification of conveyed goods.

In particular, the evaluation device includes evaluation software for identifying sensitive conveyed goods on the basis of the determined or detected at least one characteristic of the conveyed goods.

Accordingly, the sensor-based control of the transfer assistance device is designed to activate the transfer assistance device, in particular the expulsion of pressurised gas only given the presence of a sensitive conveyed good.

Alternatively to activating and deactivation the transfer assistance device or the expulsion of pressurised gas, an already present (underlying) expulsion of pressurised gas can be increased at the beginning of the transfer and be reduced again after the transfer has been effected given the presence of a sensitive conveyed good.

In particular, at least one of the following characteristics of the conveyed goods which are fed to the transfer region is detected by way of the sensor device for the sensor-based control:
shape of the conveyed good;
height of the conveyed good;
width of the conveyed good;
size of the conveyed good;
weight of the conveyed good;
alignment of the conveyed good;
nature of the conveyed good.

The at least one detected characteristic is evaluated by the evaluation device and it is determined as to whether a sensitive conveyed good is present. Accordingly, as mentioned above, the expulsion of pressurised gas is controlled via the control device in dependence on the presence of a sensitive conveyed good.

If, for example, the evaluation of the at least one detected characteristic results in a sensitive conveyed good, e.g., a bagged good being present, then via the control device the transfer assistance device is accordingly activated, in particular the expulsion of pressurised gas is activated or increased. If in contrast the evaluation of the at least one detected characteristic results in no sensitive conveyed good, e.g., a heavy parcel being present, then the transfer assistance device is not activated, in particular the expulsion of pressurised gas is not activated or increased.

Ideally, several characteristics of the conveyed good are determined or detected in order to identify sensitive conveyed goods.

Thus, for example, lightweight and comparatively flat conveyed goods, e.g., bagged goods as are typical of sensitive conveyed goods can be identified by way of a camera and scales via the evaluation unit and the associated evaluation software. Very specifically, limp bagged goods can be very specifically identified with a suitable evaluation software.

According to a further refinement, conveyed goods which have been identified as being sensitive can be divided into different categories (e.g., lightweight, medium heavy, heavy, limp bagged goods) on the basis of the determined or detected at least one characteristic.

The control device can vary the expulsion of pressurised gas in dependence on the category of the sensitive conveyed good (e.g., increased expulsion given heavy bagged goods, medium expulsion given medium-heavy bagged goods and low expulsion given lightweight bagged goods).

By way of this, the expulsion of the pressurised gas can be adapted to the characteristics such as weight or surface area of the conveyed good. This increases the reliability on transfer of the conveyed goods onto the conveying locations of the take-over conveying device.

According to a further development of the invention the expulsion of pressurised gas is controlled by means of the control device, such that the at least one conveyed good is transferred to a predefined conveying space in the take-over conveying device in an accurately targeted manner.

According to a refinement of this further development the expulsion of pressurised gas is controlled by means of the control device in dependence on at least one detected characteristic, such that the at least one conveyed good is transferred to a predefined conveying space in the take-over conveying device in an accurately targeted manner.

The horizontally or lying conveyed goods in particular are horizontally lying goods. The conveyed goods can be e.g. parcels or bagged goods. The bagged goods, e.g. plastic bags can contain textiles such as pieces of clothing. The conveyed goods can also be printed products, e.g. foiled printed products, such as magazines and brochures.

Furthermore, the control device in particular also controls the drive of the take-over conveying device and of the feed conveying device. Concerning a take-over conveying device with discrete conveying units, the control device in particular ensures a cycled transfer of the conveyed goods.

The present invention has the advantage that even sensitive conveyed goods can be transferred in an accurately targeted manner without error or disturbance by way of the transfer assistance device according to the invention. This means that the respective conveyed goods reach the envisaged conveying space or conveying place in the take-over conveying device in the envisaged position.

The transfer assistance is constructed in a simple manner and is therefore suitable for retrofitting. The pressurised gas can be obtained in the form of pressurised air from pressurised air supplies which as a rule already exist, without further investment. Such pressurised air supplies are also applied, for example, for the operation of pneumatic drives in the conveying facility.

### BRIEF DESCRIPTION OF THE DRAWINGS

The subject-matter of the invention is hereinafter explained in more detail by way of embodiment examples which are represented in the accompanying figures. In each case schematically are shown in:

FIG. 1: a plan view of an embodiment of a conveying facility according to the invention;

FIG. 2: a lateral view of a detail of a conveying facility according to the invention with the focus on the transfer region, according to an embodiment;

FIG. 3: a lateral view of a detail of a conveying facility according to the invention with the focus on the transfer region, according to a further embodiment;

FIG. 4: a perspective view of a detail of a tilt-tray conveyor;

FIG. 5: a lateral view of a detail of a tilt-tray conveyor;

FIG. 6: a plan view of a detail of a tilt-tray conveyor;

FIG. 7: a plan view of a detail of the conveying facility according to the invention with the focus on the transfer region, according to an embodiment;

FIG. 8: a plan view of a detail of the conveying facility according to the invention with the focus on the transfer region, according to a further embodiment;

FIG. 9: a plan view of a detail of the conveying facility according to the invention with the focus on the transfer region, according to a further embodiment;

FIG. 10: a lateral view of a detail of the conveying facility according to the invention with the focus on the transfer region, according to a further embodiment;

FIG. 11: a lateral view of a detail of the conveying facility according to the invention with the focus on the transfer region, according to a further embodiment.

### DETAILED DESCRIPTON OF THE INVENTION

Basically, in the figures the same parts are provided with the same reference numerals.

Certain features are not shown in the figures or are represented only in a greatly abstract manner for the understanding of the invention. The subsequently described embodiment examples are merely exemplary with regard to the subject-matter of the invention.

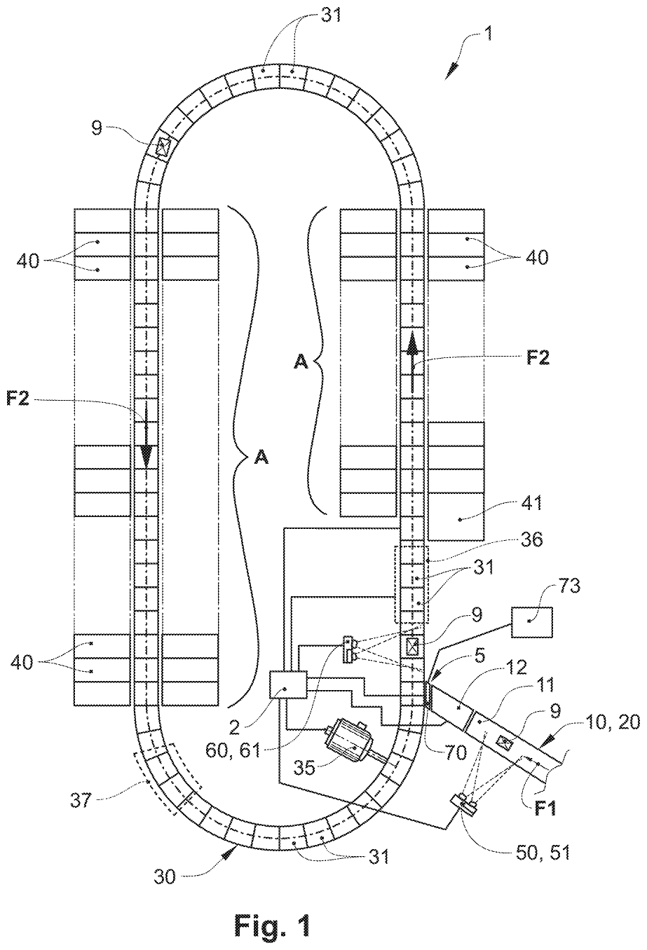

FIG. 1 shows a conveying facility 1 according to the invention, with an infeed appliance 20 for feeding or transferring conveyed goods 9 onto a take-over conveying device 30. The infeed appliance 20 includes a feed conveying device 10 with a belt conveyor 11 with a conveyor belt and with a parallel belt conveyor or strip belt conveyor 12 which connects thereto, with several conveying belts running parallel to each other in conveying direction. The parallel belt conveyor or strip belt conveyor 12 forms the conveyor which closes off and is adjacent to the take-over conveying device 30. The conveyed goods 9 are conveyed on the feed conveying device 10 in the conveying direction F1 into a transfer region TB in the transition from the feed conveying device 10 to the take-over conveying device 30 (see also FIGS. 2-3 and 7-11).

The feed conveying device 10 conveys the conveyed goods 9 to the take-over conveying device 30 from the side at an acute angle of smaller than 70° (angle degrees). The acute angle relates to the angle between the two conveying directions F1, F2 of the feed conveying device 10 and the take-over conveying device 30 in the transfer region TB, said conveying directions running towards one another.

The conveying facility 1 further includes a control device 2 for the control of the conveying facility 1.

The take-over conveying device 30 is a sorting conveyor which includes discrete conveying units 31, such as conveying trays, in particular tilt-trays. The discrete conveying units 31 in particular are interlinked to one another. The sorting conveyor 30 is designed as a revolving apparatus, on which the conveying units 31 are moved along a closed circulating path in the conveying direction F2. The sorting conveyor 30 is driven via a drive 35 which for the control of the drive 35 is connected to the control device 2.

Delivery zones A each with a plurality of delivery stations 40, at which the conveyed goods 9 are delivered in a predefined manner are arranged along the circulating path of the sorting conveyor 30.

An inclining device 36 for inclining the conveying units 31 is arranged subsequently to the transfer region and in front of the first delivery station 40 or delivery zone A considered in the conveying direction F2 of the sorting conveyor 30.

The conveying units 31 are accordingly conveyed through the delivery zone A in the inclined position. By way of a predefined release of the conveyed goods 9, these at the respective delivery stations 40 slide away from the inclined delivery units 31 towards the delivery station 40.

Furthermore, the sorting conveyor 30 includes a horizontal positioning device 37 for horizontally positioning the conveying units 31, the horizontal positioning device considered in the conveying direction F2 of the sorting conveyor 30 is subsequent to the last delivery station 40 or delivery zone A and in front of the transfer region TB. The conveying units 31 are accordingly moved into the transfer region TB in the horizontal position.

Furthermore, the sorting conveyor includes an ejecting station 41 for ejecting faulty conveyed goods 9, the ejecting station considered in the conveying direction F2 of the sorting conveyor 30 being arranged subsequently to the transfer region TB and in front of the first delivery station 40.

A transfer assistance device 70 which is hereinafter described in more detail is arranged between the sorting conveyor 30 and the feed conveying device 10. This is designed to act in the transfer region TB from below onto at least one moved-past conveyed good 9 by way of pressurised gas 72. The transfer assistance device 70 is supplied with pressurised gas from a pressurised gas supply 73. The transfer assistance device 70 in particular is arranged in a conveying gap 5 between the sorting conveyor 30 and the feed conveying device 10.

The conveying facility 1 also includes a sensor device 50. The sensor device 50 includes an opto-electronic sensor unit 51, in particular a camera, for detecting the presence of a conveyed good 9 which is arranged on the infeed appliance 20, in particular on the belt conveyor 11 of the feed conveying device 10 and accordingly fed to the transfer region TB.

The sensor device 50 as well as the transfer assistance device 70 are connected to the control device 2. Thus, the transfer assistance device 70 can be activated in a targeted manner on detection of a conveyed good 9 on the infeed appliance 20, so that pressurised gas is expelled only given the presence of a conveyed good 9 in the transfer region TB.

Apart from the presence of a conveyed good 9, in particular at least one characteristic of the conveyed good such as size (width, height, length) can also be detected with the sensor device 50.

In this manner, the transfer assistance device 70 can be activated in a targeted manner only given the detection of a sensitive conveyed good 9, such as a bag dispatch, so that pressurised gas is only expelled given the presence of a sensitive conveyed good 9 in the transfer region TB.

The conveying facility 1 further includes a further sensor device 60 with an opto-electronic sensor unit 61 such as a camera, for detecting faulty or incorrectly placed conveyed goods 9 on the sorting conveyor 30. The sensor unit 61 detects between the transfer region TB and the delivery zone A considered in the conveying direction F2.

The detail of the conveying facility 1 which is shown in FIG. 2 with the focus on the transfer region TB can, e.g., be part of the conveying facility 1 according to FIG. 1.

The infeed appliance 20 includes a feed conveying device 10 with a first and second belt conveyor 11 each with a conveying belt and with a parallel belt or strip belt conveyor 12 which is subsequent in the conveying direction F1 and which is adjacent to the take-over conveying device 30. The parallel belt or strip belt conveyor 12 corresponds to the conveyor of the feed conveying device 10 which is last in the conveying direction F1.

The take-over conveying device 30 is a tray conveyor, in particular a tilt-tray conveyor with conveying trays 31. The conveying trays 31 include lateral walls 32 which together with a conveying tray base form a receiver for the conveyed good 9.1, 9.2. According to the present embodiment, the level of the conveying surface of the feed conveying device 10 lies above the upper edge of the side walls 32 of the conveying trays 31, so that the conveyed goods 9.1, 9.2 in the transfer region TB and starting from the feed conveying device 10 are transferred horizontally over the side wall 32 of the conveying tray 31 into the receiver.

A conveying gap 5 in the form of a conveying opening is formed between the feed conveying device 10, i.e. the deflection point of the conveying belt which is at the front in the conveying direction F1, and the take-over conveying device 30, i.e. the conveying tray 31.

The transfer assistance device 10 includes an outflow body 76 which is arranged in the conveying gap 5 and is with pressurised gas nozzles 71 for the directed expulsion of pressurised gas 72. At least one of the pressurised gas nozzles 71 is designed to expel pressurised gas 72 obliquely from below with a flow component in the transfer direction T. Furthermore, at least one of the pressurised gas nozzles 71 is designed to expel pressurised gas 72 obliquely from below with a flow component counter to the transfer direction T or counter to the conveying direction F1. The expulsion of pressurised gas 72 effects a lift at the conveyed good 9.1 to be transferred, said lift counteracting gravity g. The lift prevents a premature lowering of the conveyed good 9 onto the conveying tray 31. By way of this, it is ensured that the conveyed good 9.1 is transferred without any problems over the side wall 32 into the receiver of the conveying tray 31.

Without the application of pressurised gas 72 there exists the danger of the bagged package 9.1 during the transfer being bent away downwards with a front section on account of gravity, by which means this consequently is no longer correctly, i.e. no longer completely transferred past the side wall 32 into the receiver of the conveying tray 31.

The transfer assistance device 70 also includes a switched valve 75, via which the feed of pressurised gas can be controlled. The valve 75 is controlled via the control device 2.

The transfer assistance device 70 is supplied with pressurised gas 72 via a pressurised gas supply (see, e.g., FIG. 1). The connection of the individual components such as outflow body 76, valve 75 and pressurised gas supply is effected via suitable pressurised gas conduits 74.

The opto-electronic sensor unit 51, in particular camera of the sensor device 50 detects the presence of a conveyed good 9.1, 9.2 which is arranged on the infeed appliance 20, in particular on the feed conveying device 10 and is accordingly fed to the transfer region TB, as well as also in particular at least one characteristic of the detected conveyed good 9.1, 9.2. The sensor device 50 is connected to the control device 2.

The detection of sensitive conveyed goods 9.1 has already been described further above. On detection of sensitive conveyed goods 9.1, such as e.g. bagged goods, the ejection of pressurised gas 72 via the valve 75 is activated in a time-delayed manner by way of the control device 2.

If in contrast the detected conveyed good 9.2, such as, e.g., a rigid parcel is assessed as not being problematic on account of the likewise detected at least one characteristic, then the expulsion of pressurised gas 72 is not activated.

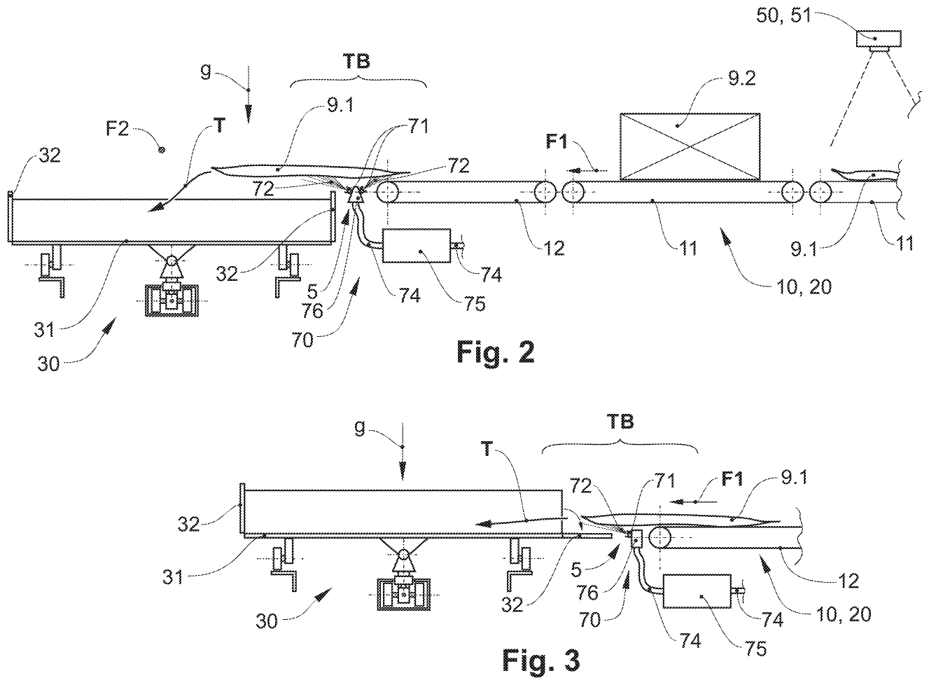

FIG. 3 shows an arrangement similar to FIG. 2 with the difference that the level of the conveying surfaces of the feed conveying device 10 and the conveying shells 31, i.e. the level of the conveying tray base are equal. The conveyed goods 9.1 can accordingly be transferred from the feed conveying device 10 to the conveying trays 31 of the take-over conveying device 30 via a horizontal transfer movement. In the transfer region TB, the pivotable side wall 32 of the conveying trays 31 which in each case faces the feed conveying device10 is pivoted down, so that the conveyed good does not need to be transferred past the side wall 32.

The transfer assistance device 70 includes at least one pressurised gas nozzle 71 which is designed to expel pressurised gas 72 obliquely from below with a flow component in the transfer direction T. By way of this, a gas cushion which reduces the sliding friction is formed between the conveying tray 31 and a leading section of the conveyed good 9.1 to be transferred, said section being arranged above the conveying tray 31 or the folded-out sidewall 32 as well as the conveying tray base. This prevents a limp conveyed good 9 with a leading section from clinging on the folded-out side wall 32 or on the conveying tray base during the transfer and being squashed by way of the following, trailing section.

With regard to further features in FIG. 3 which are identical to the features of FIG. 2, the description concerning FIG. 2 is referred to.

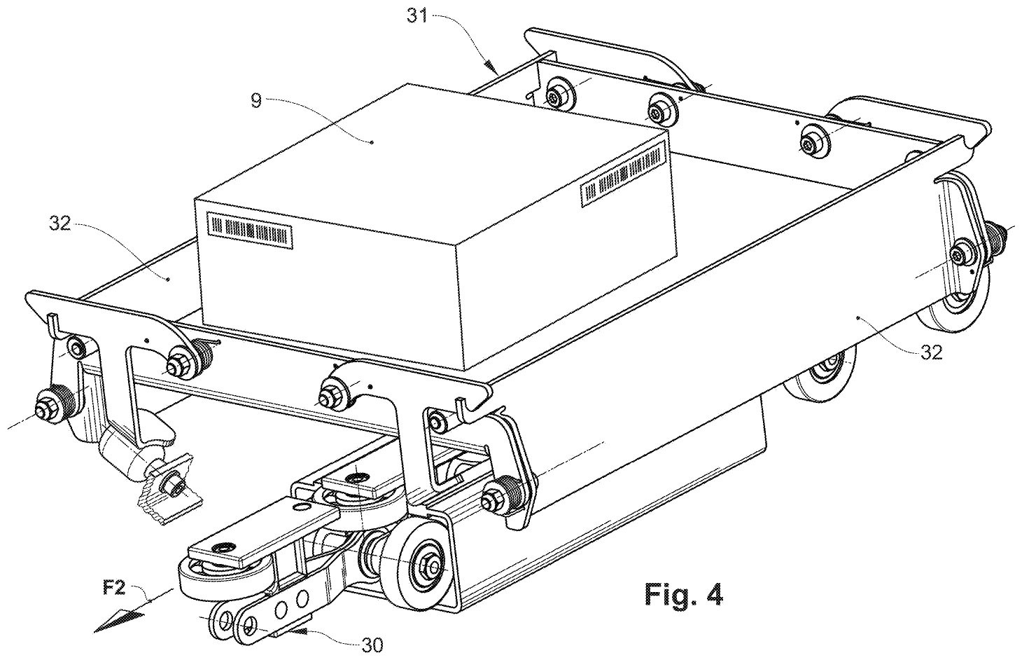

FIG. 4 by way of example shows a tilt-tray 31 of a take-over conveying device 30 which is designed as a tilt-tray conveyor. The tilt-tray 31 includes a tray base as well as side walls 32 which box this in. The side walls and tray base form a receiving compartment for a conveyed good 9. The two side walls 32 which are arranged laterally considered in the conveying direction F2 are designed in a pivotable manner and can be pivoted or folded down for receiving or for delivering conveyed goods 9. An activation mechanism is provided for pivoting down the side walls.

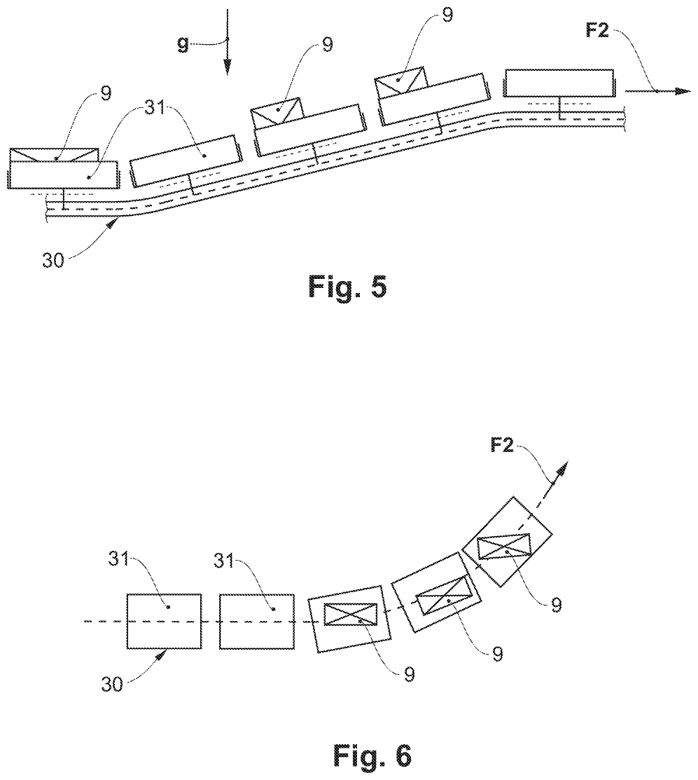

FIGS. 5 and 6 by way of example show a tilt-tray conveyor 30 with a plurality of tilt trays 31 which are arranged one after the other and are interlinked to one another. The tilt trays 31 can be led along a curved track or also along gradients.

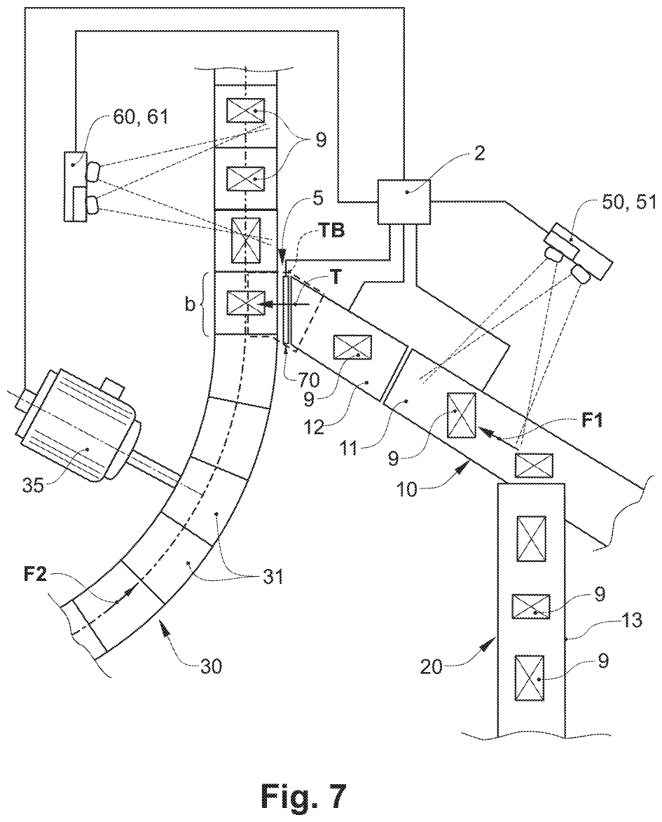

FIGS. 7 to 9 each show a detail of a conveying facility according to the invention with the focus on the transfer region TB, according to different embodiments. Features which have already been described in the context of FIG. 1 are no longer described separately here. Rather, the description concerning FIG. 1 is referred to.

According to the embodiment according to FIG. 7, the infeed appliance 20 includes the feed conveying device 10 with a belt conveyor 10 and with a connecting parallel belt conveyor or strip belt conveyor 12 of the already described type. The parallel belt conveyor or strip belt conveyor 12 corresponds to the conveyor which is last in the conveying direction F1 and is arranged in front of the take-over conveying device 30. Furthermore, the infeed appliance 20 includes a supply conveyor 13 which feeds the conveyed goods 9 to the feed conveying device 10. A transfer region TB which is represented in a dashed manner is formed in the transition from the feed conveying device 10 to the take-over conveying device 30.

Analogously to the embodiment according to FIG. 1, the feed conveying device 10 conveys the conveyed goods 9 to the take-over conveying device 30 from the side at an acute angle.

In the transfer region TB, the conveyed goods 9 are transferred or transitioned in the transfer direction T from the feed conveying device 10 to the take-over conveying device 30. The transfer direction T in the present embodiment does not correspond to the conveying direction F1, but in contrast in the transfer region TB runs at a right angle to the conveying direction F2 of the take-over conveyor 30.

The transfer region TB is characterised in that the conveyed good 9 with a leading section is already arranged over the take-over conveying device 30 and with a trailing section is still arranged over the feed conveying device 10. The transfer region TB has a width b.

The drive of the feed conveying device 10 is controlled via the control device 2. Likewise, the drive of the take-over conveying device 30 is controlled via the control device 2.

The conveying facility further includes a sensor device 50 with an opto-electronic sensor unit 51, such as a camera, for detecting the presence of a conveyed good 9 on the infeed appliance 20, in particular on the feed conveying device 10 and in particular also for detecting at least one characteristic of the conveyed goods 9 such as, e.g., the size.

The conveying facility likewise includes a further sensor device 60 with an opto-electronic sensor unit 61 such as a camera, for detecting faulty or incorrectly placed conveyed goods 9 on the sorting conveyor 30.

Both sensor devices 50, 60 are connected to the control device 2.

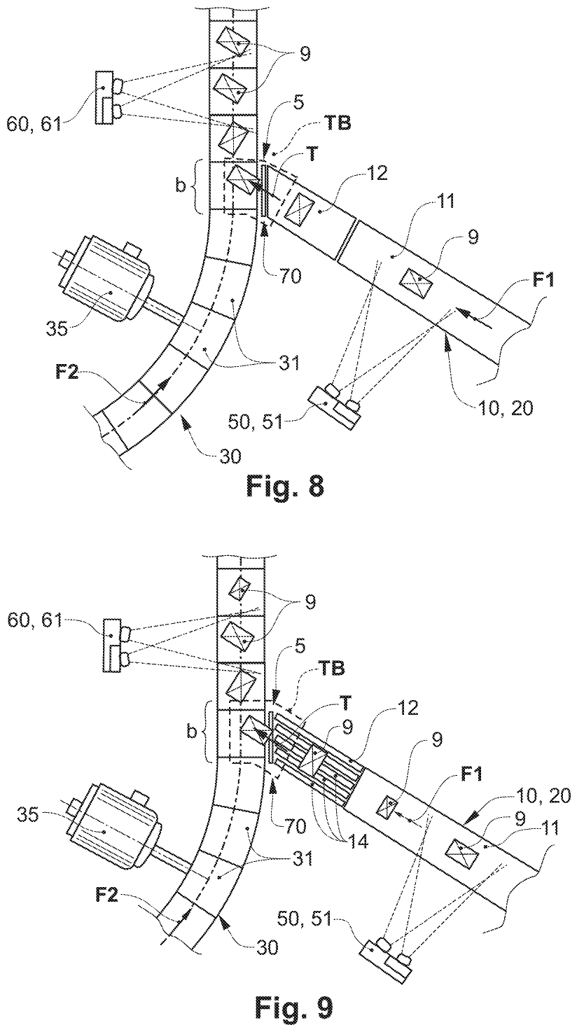

The embodiment according to FIG. 8 differs from the embodiment according to FIG. 7 amongst other things in the fact that the transfer direction T corresponds to the conveying direction F1 of the feed conveying device 10. Accordingly, the positioning of the conveyed goods 9 on the take-over conveying device 30 is also different.

In the embodiment according to FIG. 9, the parallel belt conveyor 12 of the feed conveying device 10 is represented in a more detailed manner in drawing. The parallel belt conveyor 10 includes five drivable conveying belts 14 which are arranged parallel to one another and are distanced to one another. The application of a parallel belt conveyor 12 permits a spatial grading of the conveying belts 14 given a conveying of the conveyed goods 9 at an acute angle to the take-over conveying device 30. By way of this, the conveying gap 5 is designed in a narrow manner over the complete width b of the transfer region TB or the conveying track.

Furthermore, the full width belt conveyor 12 also permits the drive of the conveying belts 14 at different speeds. By way of this, one can carry out direction changes of the conveyed goods 9 on the parallel belt conveyor 12. Thus, the conveyed goods 9 can be steered into a transfer conveying direction T which differs from the feed direction F1 of the feed conveying device 10, such as is represented for example in the embodiment according to FIG. 7, by way of conveying parallel belts 14 which are driven at different speeds.

The same characteristics are also the case concerning a strip-belt conveyor.

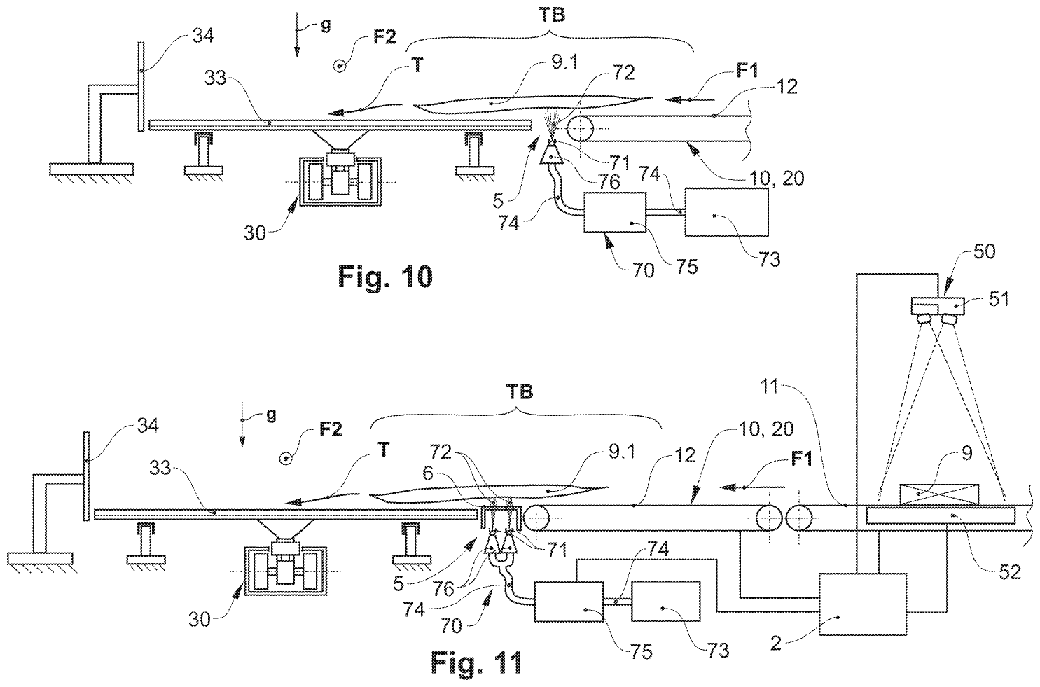

FIG. 10 shows an arrangement which is similar to FIG. 3 with the difference that the take-over conveying device 30 includes flat conveying plates 33 instead of conveying trays. Furthermore, the pressurised gas 72 via the at least one pressurised gas nozzle 71 is directed perpendicularly from below against the conveyed good 9.1 which moves past thereabove in the transfer region TB.

Here too, the pressurised gas 72 which flows perpendicularly from below against the conveyed good 9.1 effects a lifting which amongst other things leads to a formation of a gas cushion between the conveying surface or rest surface of the conveying plate 33 and a leading section of the conveyed good 9.1.

Since the conveying members of the take-over conveying device 30 which are designed as flat conveying plates 33 have no side walls, a stop 34 is provided on the side of the conveying plate 33 which lies opposite to the feed conveying device 10, said stop preventing a conveyed good 9.1 which in the transfer region TB slides or flies onto the conveying plate 33 with too much momentum from shooting or sliding beyond the conveying plate 33 on the other side.

Concerning the further features in FIG. 10 which are identical to the features of FIGS. 2 and 3, the description concerning FIGS. 2 and 3 respectively are referred to.

FIG. 11 shows an arrangement similar to FIG. 10 with the difference that the conveying gap 5 or the conveying opening is bridged by a guide element 6 which forms a sliding surface for the conveyed good 9 which is to be transferred. The guide element 6 includes at least one gas through-flow opening, through which the pressurised gas 72 which flows below out of the pressurised gas nozzles 71 of the outflow body 76 can flow upwards.

FIG. 11 further shows an expanded sensor device 50 which apart from an opto-electronic sensor unit 51, in particular a camera also includes scales or a weighing system 52 for weighing the conveyed goods 9 which are fed to the transfer region. The scales or the weighing system 52 weigh the weight of the conveyed goods 9 which are conveyed on the infeed appliance 20, in particular on the feed conveying device 10.

The sensor device 50 which is to say the opto-electronic sensor unit 51 as well as the scales or the weighing system 52 are connected to the control device 2. Likewise, the transfer assistance device 70 or its valves 75 are connected to the control device 3.

Hence apart from the size or the shape of the conveyed good 9, its weight can also be detected by the sensor device 50. Comparatively flat and simultaneously lightweight conveyed goods 9 can be detected from the determined measurement data, and these then belong to the sensitive conveyed goods with regard to the transfer onto the take-over conveying device 30.

Concerning the further features in FIG. 11 which are identical to the features of FIGS. 2, 3 and 10, the descriptions concerning FIGS. 2, 3 and 10 respectively are referred to.

1. A conveying facility with a feed conveying device, a take-over conveying device and a control device, for transferring horizontally or lying conveyed goods from the feed conveying device to the take-over conveying device, wherein the conveying facility forms a transfer region, in which the conveyed goods are transferred from the feed conveying device to the take-over conveying device, wherein
the conveying facility comprises a transfer assistance device which is designed to act in the transfer region by way of expulsion of pressurised gas from below onto at least one conveyed good which is moved past.

2. A conveying facility according to claim 1, wherein transfer assistance device comprises at least one gas outflow opening, from which pressurised gas can flow from below against the at least one conveyed good which is moved past.

3. A conveying facility according to claim 1, wherein a conveying gap is formed in the transfer region between the feed conveying device and the take-over conveying device, and the transfer assistance device is designed such that the pressurised gas acts from below through the conveying gap onto the at least one conveyed good which is moved past.

4. A conveying facility according to claim 1, wherein the control device is designed to control the expulsion of pressurised gas such that the at least one conveyed good is transferred to a predefined conveying space in the take-over conveying device in an accurately targeted manner.

5. A conveying facility according to claim 1, wherein the transfer assistance device comprises an outflow body which forms the at least one gas outflow opening, and the outflow body and in particular the at least one gas outflow opening are arranged in a stationary manner.

6. A conveying facility according to claim 1, wherein the transfer assistance device, in particular for the directed expulsion of pressurised gas comprises at least one pressurised gas nozzle which forms the at least one gas outflow opening.

7. A conveying facility according to claim 1, wherein the transfer assistance device is designed and arranged such that the pressurised gas which in the transfer region acts from below onto the at least one conveyed good imparts a lift to the conveyed good.

8. A conveying facility according to claim 1, wherein the transfer assistance device is designed and arranged such that a gas cushion is formed in the transfer region between a conveying member of the take-over conveying device and a conveyed good which with at least one section is arranged over the conveying surface of the conveying member.

9. A conveying facility according to claim 1, wherein the conveying facility comprises a sensor device for detecting the presence of a conveyed good which is fed to the transfer region.

10. A conveying facility according to claim 1, wherein the conveying facility comprises a sensor device for detecting at least one of the following characteristics of the conveyed goods which are fed to the transfer region:
shape of the conveyed good;
height of the conveyed good;
width of the conveyed good;
size of the conveyed good;
weight of the conveyed good;
alignment of the conveyed good;
nature of the conveyed good.

11. A conveying facility according to claim 10, wherein the control device is designed to control the expulsion of pressurised gas in dependence on the at least one detected characteristic, such that the at least one conveyed good is transferred to a predefined conveying space in the take-over conveying device in an accurately targeted manner.

12. A conveying facility according to claim 1, wherein the take-over conveying device is a tray conveyor with a multitude of conveying trays which are arranged one after the other along a conveying path, and the conveying trays each form a conveying space in the form of a receiving compartment for a conveyed good.

13. A method for the transfer of conveyed goods from a feed conveying device to a take-over conveying device by way of a conveying facility according to claim 1, wherein at least one conveyed good in the transfer region is subjected to onflow from below by pressurised gas by way of the transfer assistance device.

14. A method according to claim 13, wherein the expulsion of pressurised gas is controlled by means of the control device, such that the at least one conveyed good is transferred to a predefined conveying space in the take-over conveying device in an accurately targeted manner.

15. A method according to claim 13, wherein in the transfer region the pressurised gas flows through the conveying gap from below against the at least one conveyed good.

16. A method according to claim 13, wherein the presence of a conveyed good which is fed to the transfer region is detected by way of the sensor device and the expulsion of pressurised gas is controlled via the control device in dependence on the detection of a conveyed good which is fed to the transfer region.

17. A method according to claim 13, wherein at least one of the following characteristics of the conveyed goods which are fed to the transfer region is detected by way of the sensor device:
shape of the conveyed good;
height of the conveyed good;
width of the conveyed good;
size of the conveyed good;
weight of the conveyed good;
alignment of the conveyed good;
nature of the conveyed good
and the expulsion of the pressurised gas is controlled via the control device in dependence on at least one of the detected characteristics.

18. A method according to claim 17, wherein the expulsion of pressurised gas is controlled by means of the control device in dependence on the at least one detected characteristic, such that the at least one conveyed good is transferred to a predefined conveying space in the take-over conveying device in an accurately targeted manner.
